(19) United States
(12) Patent Application Publication
(10) Pub. No.: US 2025/0298348 A1
(43) Pub. Date: Sep. 25, 2025

(54) FIXING DEVICE AND IMAGE FORMING APPARATUS

(71) Applicant: FUJIFILM Business Innovation Corp., Tokyo (JP)

(72) Inventor: Yuka NOMURA, Kanagawa (JP)

(73) Assignee: FUJIFILM Business Innovation Corp., Tokyo (JP)

(21) Appl. No.: 18/820,310

(22) Filed: Aug. 30, 2024

(30) Foreign Application Priority Data
Mar. 25, 2024 (JP) 2024-048754

(51) Int. Cl. G03G 15/20

(52) U.S. Cl. CPC G03G 15/2042; G03G 15/2064; G03G 2215/2035

(57) ABSTRACT

A fixing device includes a heating member that heats a recording medium onto which an image is transferred while rotating the recording medium, and a pressing member including a body part that sandwiches the recording medium together with the heating member, that presses the recording medium toward the heating member while rotating, and that has a tubular shape, and multiple protrusions that protrude from a peripheral surface of an end part of the body part in an axial direction of the body part.

### CROSS-REFERENCE TO RELATED APPLICATIONS

This application is based on and claims priority under 35 USC 119 from Japanese Patent Application No. 2024-048754 filed Mar. 25, 2024.

### BACKGROUND

### (i) Technical Field

The present invention relates to a fixing device and an image forming apparatus.

### (ii) Related Art

A cooling device of JP2011-227315A includes a cooling roller consisting of a hollow tubular member, and a cooling medium transport unit that transports a cooling medium in the tubular member, and cools a sheet-shaped member by bringing the sheet-shaped member into contact with the cooling roller, in which a turbulence generation unit that generates turbulence in the cooling medium is provided on an inner wall of the tubular member.

### SUMMARY

A fixing device that fixes an image onto a recording medium onto which the image is transferred includes a heating member that rotates and comes into contact with the recording medium to heat the recording medium, and a pressing member including a body part that sandwiches the recording medium together with the heating member and that presses the recording medium against the heating member while rotating. A cross section of a pressing member in an axial direction of the pressing member is the same from one end to the other end.

With such a configuration, the recording medium is not sandwiched between the pressing member and the heating member at an end part of the pressing member in the axial direction, so that the end part of the pressing member is always in direct contact with the heating member. As a result, a temperature of the end part of the pressing member is higher than a temperature of a central portion of the pressing member. In other words, temperature unevenness occurs in the pressing member in the axial direction.

Aspects of non-limiting embodiments of the present disclosure relate to a fixing device and an image forming apparatus that suppresses temperature unevenness of a pressing member in an axial direction as compared with a case where a cross section of the pressing member in the axial direction is the same from one end to the other end.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a heating member that heats a recording medium onto which an image is transferred while rotating the recording medium, and a pressing member including a body part that sandwiches the recording medium together with the heating member, that presses the recording medium toward the heating member while rotating, and that has a tubular shape, and a plurality of protrusions that protrude from a peripheral surface of an end part of the body part in an axial direction of the body part.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to a first exemplary embodiment of the present disclosure;

FIG. 2 is a schematic configuration diagram showing an image forming unit provided in the image forming apparatus according to the first exemplary embodiment of the present disclosure;

FIG. 3 is a configuration diagram showing an entirety of a fixing device and the like according to the first exemplary embodiment of the present disclosure;

FIG. 4 is a perspective view showing a pressing roll of the fixing device according to the first exemplary embodiment of the present disclosure;

FIG. 5 is a schematic diagram used to describe an air flow occurring around protrusions formed on the pressing roll of the fixing device according to the first exemplary embodiment of the present disclosure;

FIG. 6 is a perspective view showing protrusions formed on an extension portion of a pressing roll of a fixing device according to a second exemplary embodiment of the present disclosure;

FIG. 7 is a perspective view showing protrusions formed on an extension portion of a pressing roll of a fixing device according to a third exemplary embodiment of the present disclosure;

FIG. 8 is a perspective view showing protrusions formed on an extension portion of a pressing roll of a fixing device according to a fourth exemplary embodiment of the present disclosure; and

FIG. 9 is a front view showing protrusions formed on a pressing roll of a fixing device according to a fifth exemplary embodiment of the present disclosure.

### DETAILED DESCRIPTION

### First Exemplary Embodiment

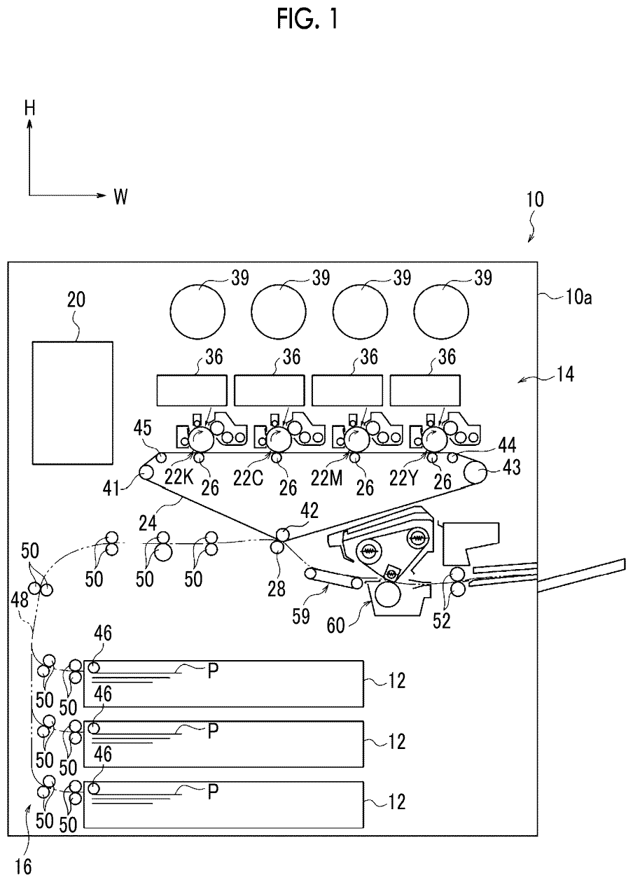

An example of a fixing device and an image forming apparatus according to an exemplary embodiment of the present disclosure will be described with reference to FIGS. 1 to 5. An arrow H shown in each drawing indicates an apparatus up-down direction, which is a vertical direction, an arrow W indicates an apparatus width direction, which is orthogonal to the arrow H and is a horizontal direction, and an arrow D indicates an apparatus depth direction, which is orthogonal to the arrows H and W and is a horizontal direction.

### Overall Configuration of Image Forming Apparatus

As shown in FIG. 1, an image forming apparatus 10 includes a housing 10a in which each component is accommodated. A plurality of accommodation sections 12 that accommodates a sheet-shaped recording medium P, an image forming section 14 that forms an image on the recording medium P, a transport section 16 that transports the recording medium P from the accommodation section 12 to the image forming section 14, and a controller 20 that controls an operation of each of the sections of the image forming apparatus 10 are provided inside the housing 10a.

### Image Forming Section 14

The image forming section 14 includes image forming units 22Y, 22M, 22C, and 22K (hereinafter, referred to as “22Y to 22K”) that form toner images of respective colors of yellow (Y), magenta (M), cyan (C), and black (K), an intermediate transfer belt 24 onto which the toner images formed by the image forming units 22Y to 22K are transferred, a primary transfer roll 26 that transfers the toner images formed by the respective image forming units 22Y to 22K onto the intermediate transfer belt 24, and a secondary transfer roll 28 that transfers the toner images transferred onto the intermediate transfer belt 24 by the primary transfer roll 26 from the intermediate transfer belt 24 to the recording medium P. In the following description, in a case where yellow, magenta, cyan, and black are not to be particularly distinguished from each other, Y, M, C, and K at ends of reference numerals are omitted.

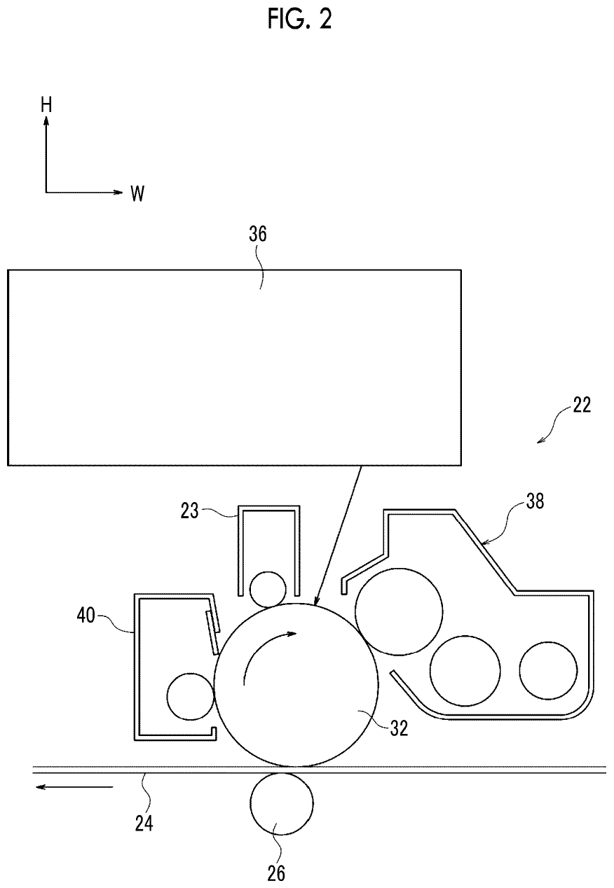

The image forming units 22 of the respective colors are disposed on an upper side of the intermediate transfer belt 24 and are arranged in the width direction. As shown in FIG. 2, each of the image forming units has an image holder 32 that rotates in a direction of an arrow in the drawing.

Around the image holder 32, a charging device 23 that charges the image holder 32, an exposure device 36 that exposes the image holder 32 charged by the charging device 23 to light to form an electrostatic latent image on the image holder 32, a developing device 38 that develops the electrostatic latent image formed on the image holder 32 by the exposure device 36 to form a toner image, and a removing device 40 that comes into contact with the image holder 32 to remove toner remaining on the image holder 32 are provided in order from an upstream side in a rotation direction of the image holder 32.

The exposure device 36 forms an electrostatic latent image based on an image signal sent from the controller 20 (see FIG. 1). In addition, as shown in FIG. 1, a toner accommodation portion 39 that accommodates toner to be supplied to the developing device 38 of the image forming unit 22 is disposed above the exposure device 36 of each color.

The intermediate transfer belt 24 is formed in a triangular shape such that a vertex faces downward. Winding rolls 41, 42, 43, 44, and 45 around which the intermediate transfer belt 24 is wound are provided on an inner peripheral side of the intermediate transfer belt 24. As an example, the intermediate transfer belt 24 circulates (rotates) in one direction (for example, a counterclockwise direction in FIG. 1) while being in contact with the image holder 32 as the winding roll 43 is rotationally driven.

The primary transfer roll 26 of each color faces the image holder 32 with the intermediate transfer belt 24 interposed therebetween. The secondary transfer roll 28 faces the winding roll 42 with the intermediate transfer belt 24 interposed therebetween. A second transfer position where the toner image transferred onto the intermediate transfer belt 24 is transferred onto the recording medium P is defined between the secondary transfer roll 28 and the winding roll 42.

The transport section 16 includes a feeding roll 46 that feeds the recording medium P accommodated in each accommodation section 12, and a plurality of transport rolls 50 that transport, to the second transfer position, the recording medium P fed by the feeding roll 46 along a transport path 48 along which the recording medium P is transported.

A belt transport section 59 that transports the recording medium P onto which the toner image is transferred by the secondary transfer roll 28 is provided on a downstream side in a transport direction of the recording medium P (hereinafter, referred to as a “medium transport direction”) with respect to the second transfer position. Further, a fixing device 60 that fixes, onto the recording medium P, the toner image transferred onto the recording medium P is disposed on the downstream side in the medium transport direction of the belt transport section 59.

Further, a discharge roll 52 that discharges the recording medium P onto which the toner image is fixed from the housing 10a is provided on the downstream side in the medium transport direction with respect to the fixing device 60. The fixing device 60 will be described in detail below.

### Image Forming Operation

Next, an image forming operation of forming an image on the recording medium P in the image forming apparatus 10 according to the present exemplary embodiment will be described.

In the image forming apparatus 10, the recording medium P fed by the feeding roll 46 from the accommodation section 12 is transported to the second transfer position by the plurality of transport rolls 50 (see FIG. 1).

On the other hand, in the image forming unit 22 of each color, the image holder 32 charged by the charging device 23 is exposed by the exposure device 36 to form an electrostatic latent image on the image holder 32 (see FIG. 2). Then, the electrostatic latent image is developed by the developing device 38 to form a toner image on the image holder 32.

The toner image of each color formed by the image forming unit 22 is superimposed on the intermediate transfer belt 24 at a first transfer position by the primary transfer roll 26 of each color, thereby forming a color image. Then, the color image formed on the intermediate transfer belt 24 is transferred onto the recording medium P by the secondary transfer roll 28.

The recording medium P onto which the toner image is transferred is transported to the fixing device 60 by the belt transport section 59, and the transferred toner image is fixed by the fixing device 60. The recording medium P onto which the toner image is fixed is discharged from the housing 10a by the discharge roll 52.

### Major Configuration

Next, a configuration of the fixing device 60 and the like according to the present exemplary embodiment will be described.

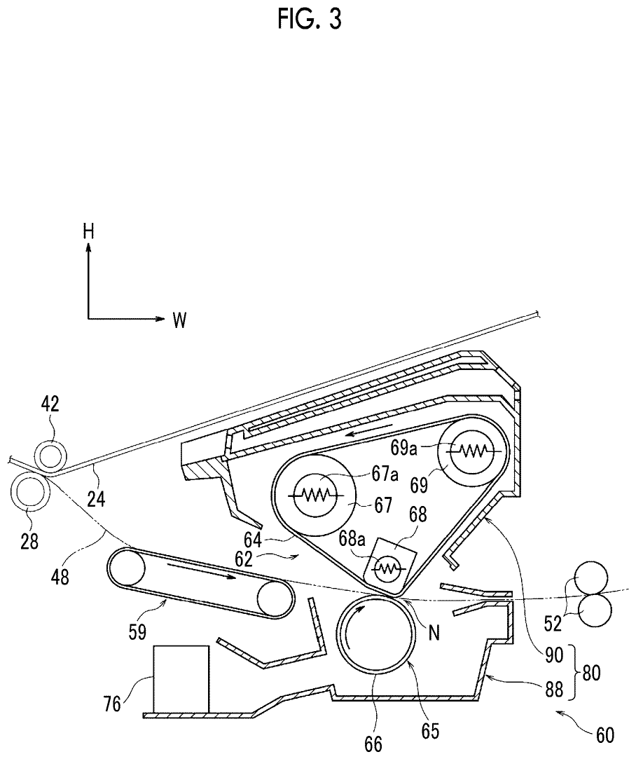

As shown in FIG. 3, the fixing device 60 includes a heating member 62, a pressing roll 65, a housing 80, and a cooling fan 76. The pressing roll 65 is an example of a pressing member.

### Housing 80

As shown in FIG. 3, the housing 80 includes an upper housing 90 in which the heating member 62 is accommodated and a lower housing 88 in which the pressing roll 65 is accommodated. The transport path 48 is provided between the upper housing 90 and the lower housing 88.

### Heating Member 62

As shown in FIG. 3, the heating member 62 includes a fixing belt 64, a pad member 68 around which the fixing belt 64 is wound, a first heating roll 69, and a second heating roll 67.

As an example, the fixing belt 64 has a configuration in which a surface of a base material made of polyamide is coated with fluororesin, and has a ring shape (endless shape). The fixing belt 64 circumferentially moves in one direction (counterclockwise direction in FIG. 3) by being driven by the pressing roll 65.

The pad member 68 extends in the depth direction, and forms a nip part N between the fixing belt 64 and the pressing roll 65 by receiving a pressing (nip) load from the pressing roll 65. In addition, a halogen heater 68a is provided inside the pad member 68.

The first heating roll 69 is disposed on the downstream side of the pad member 68 in the rotation direction of the fixing belt 64, with a rotation axis direction being the depth direction. The first heating roll 69 is cylindrical, and a halogen heater 69a is provided inside the first heating roll 69.

The second heating roll 67 is disposed on the downstream side of the first heating roll 69 in the rotation direction of the fixing belt 64, with a rotation axis direction being the depth direction. The second heating roll 67 is cylindrical, and a heating source such as a halogen heater 67a is provided inside the second heating roll 67.

### Pressing Roll 65

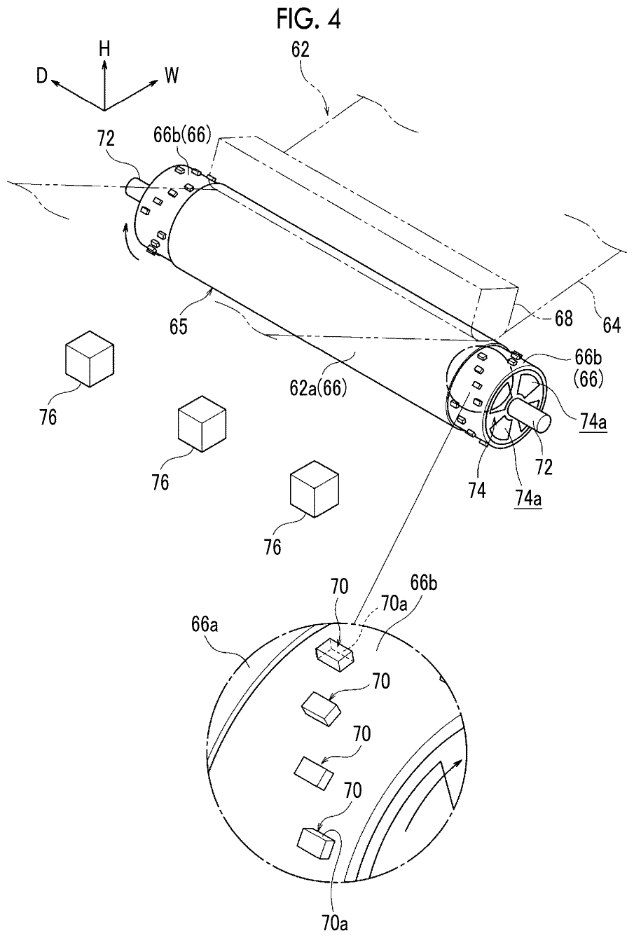

As shown in FIG. 4, the pressing roll 65 includes a cylindrical body part 66 and a shaft 72 that constitutes a rotation axis and that extends in the depth direction, with an axial direction being the depth direction. Further, the pressing roll 65 includes disk-shaped support members 74 that are provided at both end parts of the body part 66 and that support the body part 66 on the shaft 72, and protrusions 70.

The body part 66 is configured to include a facing portion 66a that faces the heating member 62 and an extension portion 66b that extends outward in the depth direction from the facing portion 66a, and the protrusions 70 protrude from an outer peripheral surface of the extension portion 66b. Here, the facing portion 66a is a portion that faces the heating member 62 and overlaps the heating member 62 in the depth direction.

### Facing Portion 66a and Extension Portion 66b

The facing portion 66a is configured by coating an outer periphery of a cylindrical member made of an aluminum alloy with an elastic layer made of silicon rubber. On the other hand, the extension portion 66b is not provided with an elastic layer made of silicon rubber, and a cylindrical outer periphery made of an aluminum alloy is exposed to the outside.

### Protrusion 70

The protrusions 70 are made of an aluminum alloy, are provided in a plurality of rows (four rows as an example in the present exemplary embodiment) in the depth direction, and are provided in a plurality of columns in the circumferential direction of the body part 66 (hereinafter, “roll circumferential direction”). The protrusion 70 has a rectangular parallelepiped shape extending in the depth direction, and the protrusion 70 is formed with a rectangular planar portion 70a extending in the depth direction and facing the rotation direction of the pressing roll 65. Here, in the present exemplary embodiment, the planar portion has an edge in contact with the extension portion 66b, and is a surface that faces a tangential direction at a contact point between the planar portion and the body part as viewed in the depth direction (axial direction).

In the present exemplary embodiment, the protrusions 70 are provided in four rows in the depth direction. One protrusion 70 and another protrusion 70 in an adjacent row in the depth direction are spaced apart from each other in the depth direction, and the protrusions 70 are disposed at equal intervals in the depth direction. In addition, the protrusions 70 provided in the rows are disposed at equal intervals in the roll circumferential direction. The depth direction is an example of the axial direction.

Specifically, the protrusions 70 in an N-th column are spaced apart from the protrusions 70 in an (N±1)-th column in the depth direction, and are arranged in a direction inclined with respect to the depth direction. Here, the protrusions being arranged in the direction inclined with respect to the depth direction mean that the protrusions are not arranged in the depth direction, and are arranged only in the direction inclined with respect to the depth direction.

### Support Member 74

The support member 74 has a disk shape, and is formed with a plurality of through-holes 74a that penetrate front and back surfaces to surround the shaft 72.

### Cooling Fan 76

As shown in FIGS. 3 and 4, a plurality of the cooling fans 76 are arranged in the depth direction and are disposed to face a lower end part of the body part 66 of the pressing roll 65 as viewed in the depth direction. The cooling fan 76 blows air to a portion of the rotating body part 66 that approaches the cooling fan 76.

### Effect of Major Configuration

Next, a fixing operation of fixing, onto the recording medium P, the toner image formed on the recording medium P will be described.

First, the pressing roll 65 shown in FIG. 3 rotates by receiving a driving force from a driving source (not shown). As a result, the fixing belt 64 provided in the heating member 62 is circumferentially driven in response to the rotation of the pressing roll 65, and the first heating roll 69 and the second heating roll 67 rotate in response to the circumferential driving of the fixing belt 64.

Further, the halogen heater 67a, the halogen heater 68a, and the halogen heater 69a are operated, and the circumferentially driving fixing belt 64 is heated by the first heating roll 69, the second heating roll 67, and the pad member 68. Further, the cooling fan 76 is operated.

Then, in a case where the fixing belt 64 is heated to a predetermined temperature, the fixing device 60 transports the recording medium P onto which the toner image is transferred by sandwiching the recording medium P at the nip part N formed by the pressing roll 65 and the fixing belt 64 of the heating member 62 while heating and pressing the recording medium P. As a result, the toner image is fixed onto the recording medium P. Further, the operating cooling fan 76 cools the pressing roll 65.

In such a fixing operation, the facing portion 66a of the rotating body part 66 is heated by the circumferentially driving fixing belt 64. Here, since the recording medium P is not sandwiched between the fixing belt 64 and the facing portion 66a at both end parts of the facing portion 66a in the depth direction, a temperature of the end part of the facing portion 66a in the depth direction (axial direction) is higher than a temperature of a central portion of the facing portion 66a in the axial direction. In other words, temperature unevenness occurs in the body part 66 of the pressing roll 65. Macroscopically, temperature unevenness occurs in the pressing roll 65. Here, the end part is a part where the pressing roll 65 always comes into direct contact with the fixing belt 64 of the heating member 62 in a case of fixing the toner image formed on the recording medium P, which is used in the largest amount, onto the recording medium P.

Hereinafter, an operation of suppressing the temperature unevenness occurring in the body part 66 (pressing roll 65) of the pressing roll 65 will be described.

In a case where the pressing roll 65 rotates, the protrusions 70 provided on the extension portion 66b also rotate. As described above, the protrusions 70 in an N-th column are spaced apart from the protrusions 70 in an (N±1)-th column in the depth direction, and the protrusions 70 adjacent to each other in the depth direction are arranged in the direction inclined with respect to the depth direction.

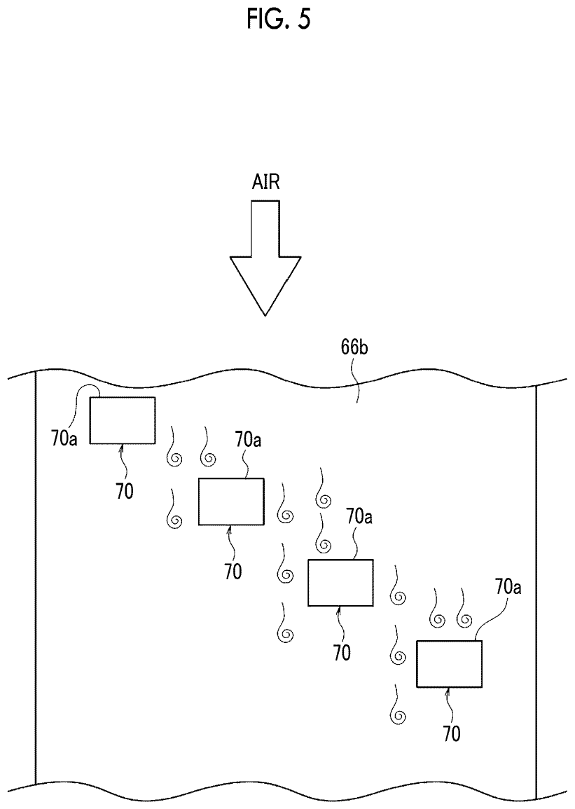

Therefore, in a case where the pressing roll 65 rotates, air hits the protrusions 70, and as shown in FIG. 5, turbulence (spiral curves shown in the drawing) is generated around the protrusions 70. In the protrusions 70 arranged in the direction inclined with respect to the depth direction, a turbulence intensity of the turbulence generated at the leading protrusion 70 in the roll circumferential direction increases in a case where the turbulence hits the next protrusion 70 in the roll circumferential direction. By repeating this process, the turbulence intensity increases.

Then, the heat of the end part of the heated facing portion 66a is dissipated by the protrusions 70 provided on the extension portion 66b. As a result, the temperature unevenness in the depth direction that occurs in the pressing roll 65 is suppressed. As described above, the protrusions 70 function as a heat dissipation fin.

### Summary

As described above, in the fixing device 60, a plurality of the protrusions 70 are formed on the extension portion 66b of the pressing roll 65. As a result, the temperature unevenness in the depth direction that occurs in the pressing roll 65 is suppressed as compared with a case where the cross section of the pressing roll in the depth direction is the same from one end to the other end. In other words, the temperature unevenness in the depth direction that occurs in the pressing roll 65 is suppressed as compared with a case where the protrusions are not provided in the pressing roll.

In addition, in the fixing device 60, the protrusions 70 protrude from the outer peripheral surface of the extension portion 66b. As compared with a case where the protrusions protrude from the inner peripheral surface of the pressing roll, a peripheral speed of the protrusions is faster, so that the temperature unevenness in the depth direction that occurs in the pressing roll 65 is suppressed.

In addition, in the fixing device 60, the protrusions 70 are provided in a plurality of rows in the depth direction and are provided in a plurality of columns in the circumferential direction of the pressing roll 65. As a result, the temperature unevenness in the depth direction that occurs in the pressing roll 65 is suppressed as compared with a case where the protrusions are provided in only one row in the depth direction.

In addition, in the fixing device 60, the protrusions 70 are arranged in the direction inclined with respect to the depth direction. As compared with a case where the protrusions are arranged in the depth direction (axial direction), the air flowing on the outer peripheral surface of the extension portion 66b becomes turbulence, and the turbulence intensity is improved, so that the temperature unevenness in the depth direction that occurs in the pressing roll 65 is suppressed.

In addition, in the fixing device 60, the protrusions 70 are arranged in the direction inclined with respect to the depth direction. As compared with a case where the protrusions are arranged in a lattice shape, the air flowing on the outer peripheral surface of the extension portion 66b becomes turbulence, and the turbulence intensity is improved, so that the temperature unevenness in the depth direction that occurs in the pressing roll 65 is suppressed.

In addition, in the fixing device 60, the protrusion 70 is formed with the planar portion 70a facing the rotation direction of the pressing roll 65. As a result, as compared with a case where the protrusions are hemispherical, air resistance received by the protrusions 70 is greater, so that the heat dissipation effect is increased, and the temperature unevenness in the depth direction that occurs in the pressing roll 65 is suppressed.

In addition, in the fixing device 60, the planar portion 70a of the protrusion 70 extends in the depth direction. As a result, as compared with a case where the planar portion extends in the radial direction of the rotating pressing roll, a length of contact between the planar portion 70a and the extension portion 66b is longer, so that the heat dissipation effect is increased, and the temperature unevenness in the depth direction that occurs in the body part 66 of the pressing roll 65 is suppressed.

In addition, in the fixing device 60, the temperature unevenness in the depth direction that occurs in the body part 66 of the pressing roll 65 is suppressed, so that the output of the cooling fan 76 is weakened.

In addition, in the image forming apparatus 10, in a case where the fixing device 60 is provided, as compared with a case where the fixing device in which the cross section of the pressing roll in the depth direction is the same from one end to the other end is provided, the temperature unevenness in the depth direction that occurs in the pressing roll 65 is suppressed, so that the wrinkles generated in the recording medium P to be output are suppressed.

### Second Exemplary Embodiment

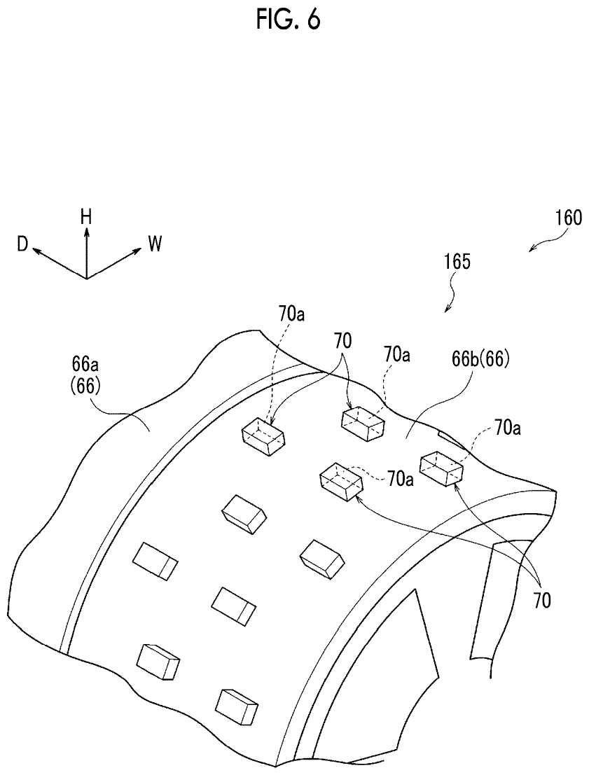

Next, an example of a fixing device 160 and an image forming apparatus according to a second exemplary embodiment will be described with reference to FIG. 6. The second exemplary embodiment will be described largely focusing on differences from the first exemplary embodiment.

As shown in FIG. 6, protrusions 70 are formed on an extension portion 66b of a pressing roll 165 of the fixing device 160 according to the second exemplary embodiment. The protrusions 70 are arranged in a staggered manner in the depth direction. The effect of the second exemplary embodiment is the same as the effect of the first exemplary embodiment.

### Third Exemplary Embodiment

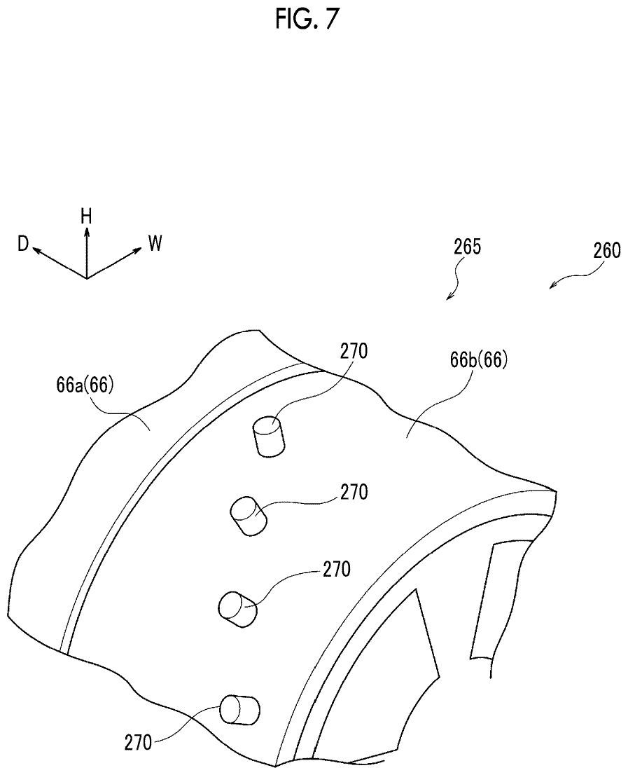

Next, an example of a fixing device 260 and an image forming apparatus according to a third exemplary embodiment will be described with reference to FIG. 7. The third exemplary embodiment will be described largely focusing on differences from the first exemplary embodiment.

As shown in FIG. 7, protrusions 270 are formed on an extension portion 66b of a pressing roll 265 of the fixing device 260 according to the third exemplary embodiment. The protrusion 270 has a cylindrical shape extending in the radial direction of the rotating pressing roll 265.

The effect of the third exemplary embodiment is the same as the corresponding effect of the first exemplary embodiment except for the effect obtained by forming the planar portion facing the rotation direction on the protrusion.

### Fourth Exemplary Embodiment

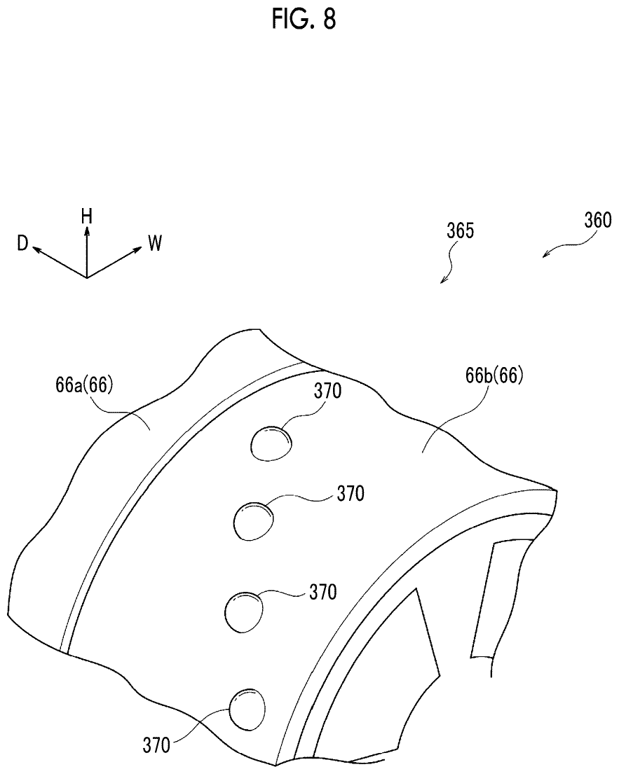

Next, an example of a fixing device 360 and an image forming apparatus according to a fourth exemplary embodiment will be described with reference to FIG. 8. The fourth exemplary embodiment will be described largely focusing on differences from the first exemplary embodiment.

As shown in FIG. 8, protrusions 370 are formed on an extension portion 66b of a pressing roll 365 of the fixing device 360 according to the fourth exemplary embodiment. The protrusion 370 has a hemispherical shape protruding in the radial direction of the rotating pressing roll 365.

The effect of the fourth exemplary embodiment is the same as the corresponding effect of the first exemplary embodiment except for the effect obtained by forming the planar portion facing the rotation direction on the protrusion.

### Fifth Exemplary Embodiment

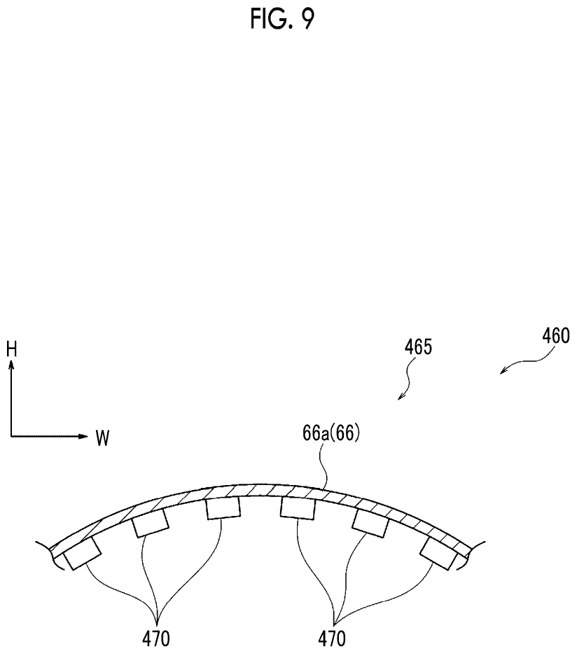

Next, an example of a fixing device 460 and an image forming apparatus according to a fifth exemplary embodiment will be described with reference to FIG. 9. The fifth exemplary embodiment will be described largely focusing on differences from the first exemplary embodiment.

A pressing roll 465 of the fixing device 460 according to the fifth exemplary embodiment is not provided with the extension portion. As shown in FIG. 9, protrusions 470 protrude from an inner peripheral surface of the end part of the facing portion 66a of the pressing roll 465. The heat of the end part of the heated facing portion 66a is directly dissipated by the protrusions 470.

In addition, the effect of the fifth exemplary embodiment is the same as the effect of the first exemplary embodiment except for the effect obtained by forming the protrusions on the outer peripheral surface.

Although the specific exemplary embodiments of the present disclosure are described in detail, the exemplary embodiment of the present disclosure is not limited to such exemplary embodiments, and it is apparent to those skilled in the art that various other exemplary embodiments can be taken within the scope of the present disclosure. For example, in the above-described exemplary embodiments, the protrusions 70, 270, 370, and 470 are provided in a plurality of rows in the depth direction, but may be provided in one row. However, in this case, the effect of providing the protrusions in a plurality of rows is not obtained.

In addition, in the above-described exemplary embodiments, the protrusions 70, 270, 370, and 470 are provided in a plurality of columns in the circumferential direction of the pressing roll, but may be provided in one column. However, in this case, the effect of providing the protrusions in a plurality of columns is not obtained.

In addition, in the above-described exemplary embodiments, the protrusions 70, 270, 370, and 470 are provided in a plurality of rows in the depth direction and are provided in a plurality of columns in the circumferential direction of the pressing roll, but a plurality of the protrusions may be provided at random (without regularity).

In addition, in the above-described exemplary embodiments, the protrusions 70, 370, and 470 are arranged in the direction inclined with respect to the depth direction, but the protrusions may be arranged in a lattice shape. However, in this case, the effect of arranging the protrusions in the direction inclined with respect to the depth direction is not obtained.

In addition, in the above-described exemplary embodiments, the protrusions 70 and 270 have a rectangular parallelepiped shape, but may have other shapes. In this case, the effect of the protrusion being a rectangular parallelepiped is not obtained.
(((1)))

A fixing device comprising:
a heating member that heats a recording medium onto which an image is transferred while rotating the recording medium; and
a pressing member including a body part that sandwiches the recording medium together with the heating member, that presses the recording medium toward the heating member while rotating, and that has a tubular shape, and a plurality of protrusions that protrude from a peripheral surface of an end part of the body part in an axial direction of the body part.
(((2)))

The fixing device according to (((1)))
wherein the body part includes a facing portion that faces the heating member and an extension portion that extends outward in the axial direction from the facing portion, and
the protrusions protrude from an outer peripheral surface of the extension portion.
(((3)))

The fixing device according to (((1))),
wherein the protrusions are provided in a plurality of rows in the axial direction and are provided in a plurality of columns in a circumferential direction of the pressing member.
(((4)))

The fixing device according to any one of (((1))) to (3)),
wherein the protrusions are arranged in a direction inclined with respect to the axial direction.
(((5)))

The fixing device according to any one of (((1))) to (((3)))),
wherein the protrusions are arranged in a staggered manner with respect to the axial direction.
(((6)))

The fixing device according to any one of (((1))) to (((5))),
wherein the protrusions are each formed with a planar portion facing a rotation direction of the pressing member.
(((7)))

The fixing device according to (((6))),
wherein the planar portion extends in the axial direction.
(((8)))

An image forming apparatus comprising:
an image forming section that forms an image on a recording medium; and
the fixing device according to any one of (((1))) to (((7))), which fixes the image onto the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating member that heats a recording medium onto which an image is transferred while rotating the recording medium; and
a pressing member including a body part that sandwiches the recording medium together with the heating member, that presses the recording medium toward the heating member while rotating, and that has a tubular shape, and a plurality of protrusions that protrude from a peripheral surface of an end part of the body part in an axial direction of the body part.

2. The fixing device according to claim 1,
wherein the body part includes a facing portion that faces the heating member and an extension portion that extends outward in the axial direction from the facing portion, and
the protrusions protrude from an outer peripheral surface of the extension portion.

3. The fixing device according to claim 1,
wherein the protrusions are provided in a plurality of rows in the axial direction and are provided in a plurality of columns in a circumferential direction of the pressing member.

4. The fixing device according to claim 3,
wherein the protrusions are arranged in a direction inclined with respect to the axial direction.

5. The fixing device according to claim 3,
wherein the protrusions are arranged in a staggered manner with respect to the axial direction.

6. The fixing device according to claim 1,
wherein the protrusions are each formed with a planar portion facing a rotation direction of the pressing member.

7. The fixing device according to claim 6,
wherein the planar portion extends in the axial direction.

8. An image forming apparatus comprising:
an image forming section that forms an image on a recording medium; and
the fixing device according to claim 1, which fixes the image onto the recording medium.

9. An image forming apparatus comprising:
an image forming section that forms an image on a recording medium; and
the fixing device according to claim 2, which fixes the image onto the recording medium.

10. An image forming apparatus comprising:
an image forming section that forms an image on a recording medium; and
the fixing device according to claim 3, which fixes the image onto the recording medium.

11. An image forming apparatus comprising:
an image forming section that forms an image on a recording medium; and
the fixing device according to claim 4, which fixes the image onto the recording medium.

12. An image forming apparatus comprising:
an image forming section that forms an image on a recording medium; and
the fixing device according to claim 5, which fixes the image onto the recording medium.

13. An image forming apparatus comprising:
an image forming section that forms an image on a recording medium; and
the fixing device according to claim 6, which fixes the image onto the recording medium.

14. An image forming apparatus comprising:
an image forming section that forms an image on a recording medium; and
the fixing device according to claim 7, which fixes the image onto the recording medium.
